(19) United States
(12) Patent Application Publication
(10) Pub. No.: US 2015/0364915 A1
(43) Pub. Date: Dec. 17, 2015

(54) HIGH FREQUENCY MODULE

(71) Applicant: ALPS ELECTRIC CO., LTD., Tokyo (JP)

(72) Inventors: Jun SUGAWARA, Tokyo (JP); Yoshikazu FURUYAMA, Tokyo (JP)

(21) Appl. No.: 14/695,655

(22) Filed: Apr. 24, 2015

(30) Foreign Application Priority Data
Jun. 11, 2014 (JP) 2014-120556

(51) Int. Cl. H02H 9/04

(52) U.S. Cl. CPC H02H 9/044

(57) ABSTRACT

A high frequency module includes a wiring substrate and a metal shield cover. A wiring conductor through which a high frequency signal is transferred and which is coupled to the electronic component, a wiring electrode which is coupled to the wiring conductor and is provided in an outside further than the shield cover, and a ground electrode which is coupled to the shield cover, are provided on the wiring substrate. The shield cover includes a side plate which is formed of a metal of a plate shape, and a leg portion which is provided in the side plate and is soldered to the ground electrode. A gap is formed between the side plate and the wiring substrate, and the wiring conductor is disposed so as to intersect the side plate in a planar view, on the wiring substrate which is positioned below the gap.

### CLAIM OF PRIORITY

This application contains subject matter related to and claims the benefit of Japanese Patent Application No. 2014-120556, filed on Jun. 11, 2014, the entire contents of which is incorporated herein by reference.

### BACKGROUND OF THE DISCLOSURE

1. Field of the Disclosure

The present disclosure relates to a high frequency module, and particularly to a high frequency module which can prevent damage due to static electricity discharge to an electronic component.

2. Description of the Related Art

In recent years, for a high frequency module in which a high frequency circuit such as a wireless LAN is mounted, an ESD protection element for taking an electro-static discharge (ESD) measure has been used. However, being generally capacitive, an ESD protection element affects performance of a high frequency circuit. Thus, it is desirable that a high frequency module takes an ESD measure, without using an ESD protection element which affects performance of a circuit.

An electronic circuit unit which is configured to take an ESD measure without using an ESD protection element is disclosed in Japanese Unexamined Patent Application Publication No. 2012-018857. A structure of an electronic circuit unit 900 which is disclosed in Japanese Unexamined Patent Application Publication No. 2012-018857 is illustrated in FIG. 4 of that reference.

The electronic circuit unit 900 includes an insulating substrate 904, and a capacitive cover 905 which covers at least a portion of a substrate surface of the insulating substrate 904. A first side surface electrode 911 and a second side surface electrode 912 are formed on a side surface of the insulating substrate 904, a leg portion 915 of the cover 905 and the first side surface electrode 911 are soldered to each other, and a protrusion 916 is formed in the cover 905 so as to face the second side surface electrode 912. Meanwhile, the first side surface electrode 911 is configured as a ground electrode of the electronic circuit unit 900. In addition, the second side surface electrode 912 is configured as a power supply electrode of the electronic circuit unit 900.

According to this configuration, the protrusion 916 which faces the second side surface electrode 912 is formed in the cover 905, and thereby a distance between the second side surface electrode 912 and the cover 905 which is configured as a ground potential becomes small, and corona discharge easily occurs. Thus, in a case in which static electricity is discharged to the second side surface electrode 912, the static electricity is appropriately discharged to the cover 905 via the protrusion 916, and it is possible to prevent an electronic circuit component or the like on the insulating substrate 904 from malfunctioning or being damaged. In addition, even in a case in which an interval between the cover 905 and the second side surface electrode 912 is wide, the static electricity is discharged to the cover 905 side via the protrusion 916, and thereby even if accuracy of a position in which the cover 905 is attached to the insulating substrate 904 is low, an electrostatic measure can be taken.

However, in a case in which an ESD measure for an electronic circuit unit 900 which is disclosed in Japanese Unexamined Patent Application Publication No. 2012-018857 is used for a wiring electrode for a high frequency circuit of a high frequency module, there is the following problem.

In the electronic circuit unit 900, a coupling capacitance is generated between a tip portion of a protrusion 916 and a second side surface electrode 912. In addition, an electrode such as the second side surface electrode 912 is coupled to a mother substrate 902 via a solder S thereby being attached. Thus, the second side surface electrode 912 is coated with the solder S, and is configured to be fixed. An amount of the solder S is not necessarily constant in a manufacturing process. As a result, a distance between a tip portion of the protrusion 916 and the second side surface electrode 912 is subject to variation. Thus, a capacitive value of a coupling capacitance which is generated between a tip portion of the protrusion 916 and the second side surface electrode 912 varies.

In a case of the electronic circuit unit 900, the second side surface electrode 912 is configured to be used as a power supply electrode, and thus even if a coupling capacitance between a tip portion of the protrusion 916 and the second side surface electrode 912 varies, performance issues do not occur in particular. However, in a case in which the second side surface electrode 912 of the electronic circuit unit 900 is used as a wiring electrode of a high frequency circuit, a coupling capacitance varies between the wiring electrode and the protrusion 916, that is, between a wiring electrode of a high frequency circuit and a ground potential. In a case in which a coupling capacitance between a wiring electrode of a high frequency circuit and a ground potential varies, the variation affects performance of a high frequency circuit. Particularly, in a case in which a high frequency circuit which is coupled to a wiring electrode is an antenna circuit, the high frequency circuit affects antenna characteristics.

These and other drawbacks exist.

### SUMMARY OF THE DISCLOSURE

The embodiments of the present disclosure provide a high frequency module which can take an ESD measure without affecting performance of the high frequency circuit.

A high frequency module of the present disclosure includes a wiring substrate in which an electronic component is mounted; and a metal shield cover which is placed on the wiring substrate, in which a wiring conductor through which a high frequency signal is transferred and which is coupled to the electronic component, a wiring electrode which is coupled to the wiring conductor and is provided in an outside further than the shield cover, and a ground electrode which is coupled to the shield cover, are provided on the wiring substrate, in which the shield cover includes a side plate which is formed of a metal of a plate shape, and a leg portion which is provided in the side plate and is soldered to the ground electrode, and in which a gap is formed between the side plate and the wiring substrate, and the wiring conductor is disposed so as to intersect the side plate in a planar view, on the wiring substrate which is positioned below the gap.

In the high frequency module which is configured in this way, the wiring conductor is disposed so as to intersect the side plate in a planar view, and thereby a value of a coupling capacitance between the wiring conductor and the side plate can be constant. As a result, it is possible to take an ESD measure without affecting performance of the high frequency circuit.

In addition, in the configuration, an angle which is formed by the wiring conductor and the side plate may be a right angle.

In the high frequency module which is configured in this way, an angle which is formed by the wiring conductor and the side plate is a right angle, and thereby an area at which the wiring conductor and the side plate intersect each other can be reduced in a minimum manner. For this reason, a value of a coupling capacitance between the wiring conductor and the side plate can be smallest, and a high frequency circuit can be easily designed.

In addition, in the configuration, an end portion of the leg portion may be in contact with the ground electrode.

In the high frequency module which is configured in this way, it is possible to accurately set a separation distance between the wiring conductor and the side plate.

In addition, in the configuration, an antenna may be coupled to the wiring electrode.

In the high frequency module which is configured in this way, in a case in which the antenna is coupled to the wiring electrode, power loss of a signal which is transmitted to or received from the antenna can be reduced, and static electricity can be easily discharged.

In a high frequency module of the present disclosure, a wiring conductor is disposed so as to intersect a side plate in a planar view, and thereby a value of a coupling capacitance between the wiring conductor and the side plate can be constant. As a result, it is possible to take an ESD measure without affecting performance of a high frequency circuit.

### BRIEF DESCRIPTION OF THE DRAWINGS

FIG. 1 is a perspective view illustrating an appearance of a high frequency module according to an example embodiment of the disclosure;

FIG. 2A and FIG. 2B are respectively a side view and a plan view of a high frequency module according to an example embodiment of the disclosure;

FIG. 3 is a schematic diagram illustrating a state of air discharge according to an example embodiment of the disclosure; and

FIG. 4 is a perspective view illustrating an appearance of an electronic circuit unit according to an example of the related art.

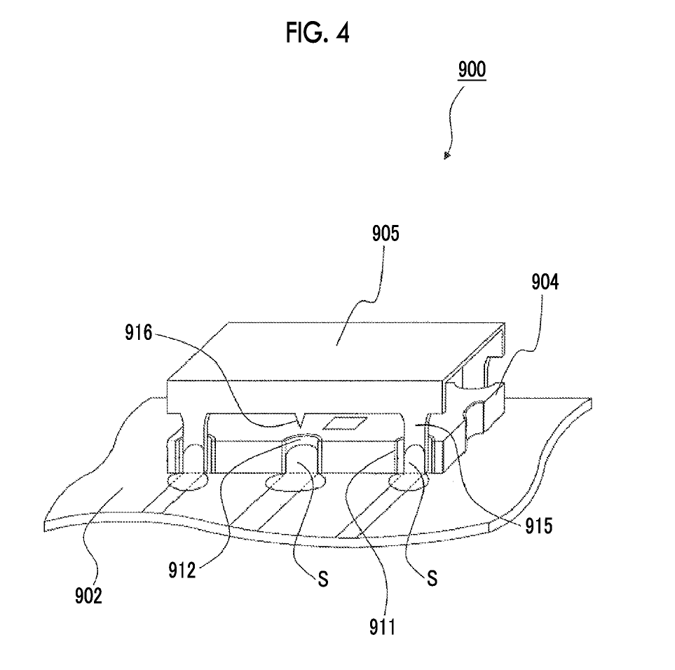

### DETAILED DESCRIPTION OF THE DISCLOSURE

The following description is intended to convey a thorough understanding of the embodiments described by providing a number of specific embodiments and details involving a pressure detection device and intake pressure measurement apparatus. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

Hereinafter, an embodiment of the present invention will be described with reference to the drawings. Meanwhile, in the present specification, unless otherwise noted, X1 of each drawing is referred to as a right side, X2 of each drawing is referred to as a left side, Y1 of each drawing is referred to as a far side, Y2 of each drawing is referred to as a front side, Z1 of each drawing is referred to as an upper side, and Z2 of each drawing is referred to as a lower side.

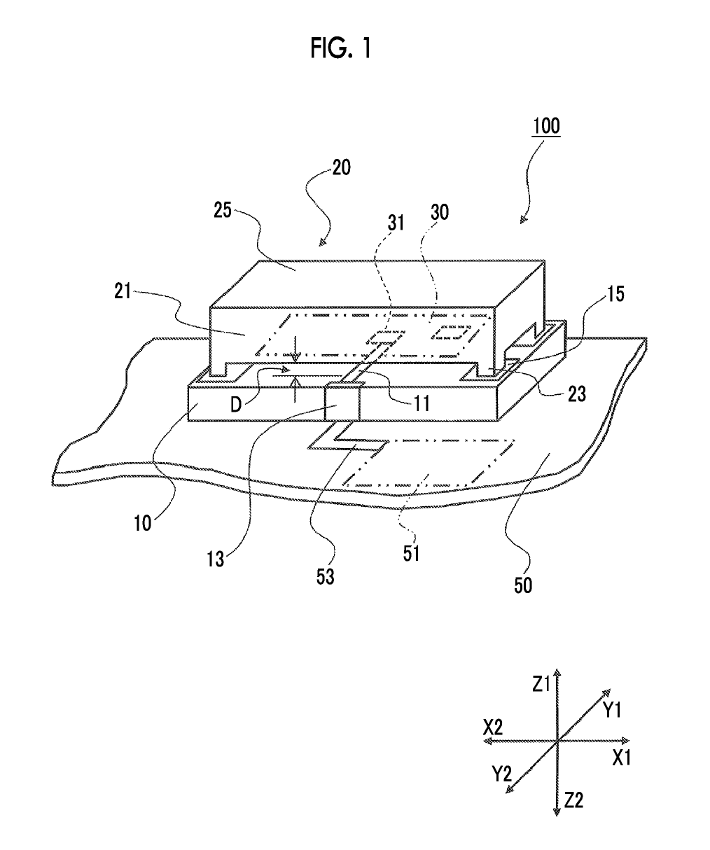

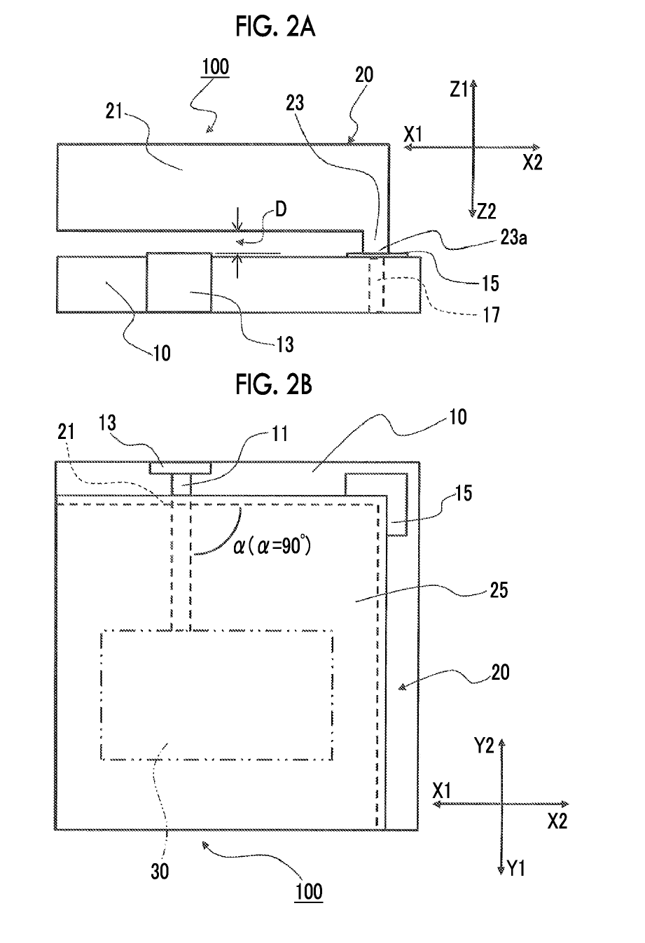

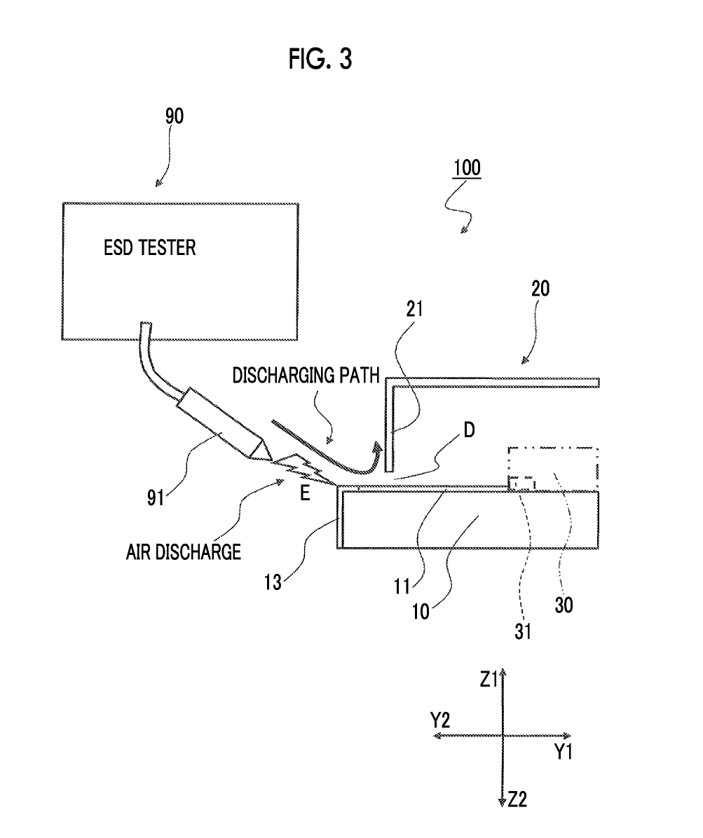

FIG. 1 is a perspective view illustrating an appearance of an example high frequency module 100, and FIG. 2A and FIG. 2B are respectively a side view and a plan view of a high frequency module 100. FIG. 3 is a schematic diagram illustrating a state of air discharge with respect to the high frequency module 100.

As illustrated in FIG. 1, the high frequency module 100 may include a wiring substrate 10 in which an electronic component 31 may be mounted, and a metal shield cover 20 which may be placed on the wiring substrate 10.

A wiring conductor 11 through which a high frequency signal is transferred and which is coupled to the electronic component 31, a wiring electrode 13 which is coupled to the wiring conductor 11 and is provided in an outside further than the shield cover 20, and a ground electrode 15 which is coupled to the shield cover 20, may be provided on the wiring substrate 10. In the high frequency module 100, a high frequency circuit 30 may be configured by the electronic component 31, the wiring conductor 11, another wiring conductor which is not illustrated, and the like. The wiring electrode 13 may be a terminal for antenna-coupling. Herein, the wiring electrode 13 may be provided as a side surface electrode which is formed on a side surface of the wiring substrate 10, but if being coupled to the wiring conductor 11, the electrode 13 may be an electrode which is provided on a lower surface of the wiring substrate 10.

The shield cover 20 may be a metal of a plate shape, and may include a top plate 25 of a rectangular shape which has a surface in parallel with the wiring substrate 10, and a side plate 21 which may extend from each side of the top plate 25 and may be formed of a metal of a plate shape. The shield cover 20 may be attached to the wiring substrate 10 so as to cover the above-described high frequency circuit 30, and may shield the high frequency circuit 30 using a high frequency shield. A plurality of leg portions 23 may be provided in the side plate 21, and the leg portions 23 may be soldered to the ground electrode 15 on the wiring substrate 10.

As illustrated in FIG. 1, the high frequency module 100 may be attached on a mother board 50 which may be included in an electronic apparatus (not illustrated). Various circuits (not illustrated) may be mounted in the mother board 50, and a portion of the circuits may be coupled to the high frequency module 100. In addition, an antenna 51 may be mounted on the mother board 50, and the antenna 51 may be coupled to the wiring electrode 13 of the high frequency module 100 via a conductor 53 for antenna-coupling.

As illustrated in FIG. 1 and FIG. 2A, a gap D may be formed between the side plate 21 and the wiring substrate 10. Then, as illustrated in FIG. 1 and FIG. 2B, the wiring conductor 11 may be disposed so as to intersect the side plate 21 in a planar view, on the wiring substrate 10 which is positioned below the gap D. Particularly, the wiring conductor 11 may be disposed in such a manner that an angle a which is formed by the wiring conductor 11 and the side plate 21 is a right angle, as illustrated in FIG. 2B. It is enough to only produce the shield cover 20 of the high frequency module 100 in such a manner that the gap D is formed between the side plate 21 and the wiring substrate 10, and thus it is not necessary to form the side plate 21 in a particular structure, and it is easy to produce and manage the shield cover 20.

As described above, the leg portion 23 may be provided in the side plate 21, and may be soldered to the ground electrode 15 on the wiring substrate 10. As illustrated in FIG. 2B, the leg portion 23 may be attached in such a manner that an end portion 23a thereof is in contact with the ground electrode 15. Meanwhile, an attachment portion for being attached to the wiring substrate 10 or the like may be additionally provided in the leg portion 23, but it may be necessary for the end portion 23a of the leg portion 23 which determines a height of attachment of the side plate 21 to be placed in a state of being in contact with the ground electrode 15. In addition, the ground electrode 15 may be coupled to a ground pattern (not illustrated) of the mother board 50 via a through-hole 17. As a result, a potential of the shield cover 20 may become the same potential as the ground pattern of the mother board 50.

Next, a state of air discharge with respect to the high frequency module 100 will be described. An ESD test may be performed with respect to the high frequency module 100.

As illustrated in FIG. 3, an ESD test with respect to the high frequency module 100 may be performed using an ESD tester 90. In the ESD tester 90, static electricity E may be generated by a predetermined capacitance value and a predetermined high voltage value. The generated static electricity E may be air-discharged to the wiring electrode 13 of the high frequency module 100 via a probe 91 which may be attached to the ESD tester 90.

In a case in which the embodiments of present disclosure are not applied, the static electricity E which is air-discharged to the wiring electrode 13 of the high frequency module 100 is subject to being applied to the electronic component 31 in the high frequency circuit 30 via the wiring conductor 11 from the wiring electrode 13. As a result, there is a possibility that the electronic component 31 may be damaged by static electricity. However, in a case in which the embodiments of the present disclosure is applied, as illustrated in FIG. 3, the static electricity E which is air-discharged is discharged via a portion of the wiring conductor 11, the gap D, and a discharging path from the wiring electrode 13 to the side plate 21 of the shield cover 20. Next, the static electricity E which is transferred to the shield cover 20 may be guided to a ground pattern (not illustrated) of the mother board 50 via the leg portion 23 of the shield cover 20 which is illustrated in FIG. 2A, the ground electrode 15 of the wiring substrate 10, and the through-hole 17. Thus, the static electricity E is not applied to the electronic component 31 in the high frequency circuit 30. For this reason, the electronic component 31 is not damaged by an electrostatic discharge.

In this way, in the high frequency module 100, the wiring conductor 11 may be disposed so as to intersect the side plate 21 in a planar view, and thereby a value of a coupling capacitance between the wiring conductor 11 and the side plate 21 can be constant. As a result, it is possible to take an ESD measure without affecting performance of the high frequency circuit 30.

In addition, an angle which is formed by the wiring conductor 11 and the side plate 21 is a right angle, and thereby an area at which the wiring conductor 11 and the side plate 21 intersect each other can be minimally reduced. For this reason, a value of a coupling capacitance between the wiring conductor 11 and the side plate 21 can be smallest, and the high frequency circuit 30 can be easily designed.

In addition, the end portion 23a of the leg portion 23 may be in contact with the ground electrode 15, and thereby, it is possible to accurately set a distance between the wiring conductor 11 and the side plate 21, that is, a separated distance of the gap D.

In addition, in a case in which the antenna 51 is coupled to the wiring electrode 13, power loss of a signal which may be transmitted to or received from the antenna 51 can be reduced, and static electricity can be easily discharged.

As illustrated above, in the high frequency module of the present disclosure, the wiring conductor may be disposed so as to intersect the side plate in a planar view, and thereby the value of a coupling capacitance between the wiring conductor and the side plate can be constant. As a result, it is possible to take an ESD measure without affecting performance of a high frequency circuit.

As described above, the high frequency module 100 according to the embodiment of the present disclosure is described, but the present invention is not limited to the above-described embodiment, and can be implemented by various modifications within a range without departing from the gist.

It should be understood by those skilled in the art that various modifications, combinations, sub-combinations, and alterations may occur depending on design requirements and other factors insofar as they are within the scope of the appended claims of the equivalents thereof.

Accordingly, the embodiments of the present inventions are not to be limited in scope by the specific embodiments described herein. Further, although some of the embodiments of the present disclosure have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. A high frequency module comprising:
a wiring substrate in which an electronic component is mounted; and
a metal shield cover which is placed on the wiring substrate,
wherein, a wiring conductor through which a high frequency signal is transferred and which is coupled to the electronic component, a wiring electrode which is coupled to the wiring conductor and is provided in an outside further than the shield cover, and a ground electrode which is coupled to the shield cover, are provided on the wiring substrate,
wherein the shield cover includes a side plate which is formed of a metal of a plate shape, and a leg portion which is provided in the side plate and is soldered to the ground electrode, and
wherein a gap is formed between the side plate and the wiring substrate, and the wiring conductor is disposed so as to intersect the side plate in a planar view, on the wiring substrate which is positioned below the gap.

2. The high frequency module according to claim 1, wherein an angle which is formed by the wiring conductor and the side plate is a right angle.

3. The high frequency module according to claim 1, wherein an end portion of the leg portion is in contact with the ground electrode.

4. The high frequency module according to claim 1, wherein an antenna is coupled to the wiring electrode.
